(19) United States
(12) Patent Application Publication
(10) Pub. No.: US 2005/0190899 A1
(43) Pub. Date: Sep. 1, 2005

(54) Device and process for assembling and delivering on-hold messages for business telephone systems

(76) Inventor: Arthur Allan Rhodes JR., Plano, TX (US)

Correspondence Address: F. Lindsey Scott, Suite B, 2329 Coit Road, Plano, TX, 75075, US

(21) Appl. No.: 10/874,507

(22) Filed: Jun. 23, 2004

Related U.S. Application Data
(60) Provisional application No. 60/484,175, filed on Jun. 30, 2003.

(51) Int. Cl. H04M 11/00; H04B 7/00

(52) U.S. Cl. 379/101.01

(57) ABSTRACT

An on-hold message-playing device is connected to a business telephone system to play music and voice content, which is stored in memory and played back to callers who are placed on “hold”. Voice elements are written by the provider company in collaboration with the customer, recorded and edited in the provider's production studio, and saved to the provider's electronic storage media. Customers are then able to access the provider interface via the Internet, select from the individual voice elements and available music tracks, and produce messages played from the device's audio output connected to the customer's telephone system. Depending on its configuration, the playback device receives these new productions either by a connection to the Internet, or to the Public Switched Telephone Network (PSTN). In the Internet-connected configuration the playback device periodically establishes a connection to the provider's server via the Internet and polls for any waiting message intended for that specific device. If a new message is waiting, the device downloads the new production data and stores them digitally. In the PSTN-connected configuration the device passively awaits an incoming call whereby data comprising the new production are downloaded. In either configuration, once the production download is complete, the voice and music elements are played by the device through a connection to the customer premises phone system, where they are then heard by callers who have been placed on hold.

### FIELD OF THE INVENTION

The present invention relates to devices, systems, and processes whereby audio messages, music, and other content are acquired and then played via the on-hold function of multi-line telephone systems.

### BACKGROUND OF THE INVENTION

Most multi-line telephone systems in use by commercial, governmental, and other entities have a function with which the user can place the other party(ies) to the conversation “on hold” for a period of time. This allows the users of the phone to maintain the established connection while they go about another task; e.g. transferring the call to another station, researching information, setting up a conference call, consulting with another party and the like. Some multi-line telephone systems on which incoming calls are answered by an “automated attendant” effectively place the incoming call on hold until it can be answered by a human operator or after the calling party has selected a desired action from the choices presented by the automated attendant.

When the user or automated attendant places the call on hold, the other party will hear only silence unless some method is employed to provide music, messages, or other audio content. Multi-line telephone systems generally are either a key system type controlled by a Key Service Unit (KSU), or are a PBX (Private Branch Exchange) type. The majority of systems of either type have or can be adapted to accommodate on-hold audio, which is input continuously to a designated “Music On Hold” (MOH) port of the telephone system controlling device and in turn played over the holding phone line. Key benefits of having audio, rather than silence, are: assurance to holding callers that the connection remains in place; provision of music and other content to minimize boredom; and utilization of the opportunity to deliver marketing and other sales-generating or informational messages.

Although the PBX or KSU usually has circuitry for delivering audio content to holding callers, the source of this content is generally left to the discretion of the owner of the telephone system (customer). Because of copyright laws, use of commercial radio broadcast or pre-recorded music requires payment of license fees, since this use is considered public performance. In view of this consideration, and given the opportunity to deliver marketing-oriented on-hold messages, many businesses and other entities elect to use audio sources provided by a company specializing in preparation and delivery of such content.

Some technologies for this purpose incorporate magnetic tape cassette or Compact Disc (CD) media. Depending on the model of the playback unit, the production may be played directly from the recording medium (CD or magnetic tape), or it may be downloaded from the medium into memory devices within the playback unit, which stores and plays it. Other technologies utilize dial-in delivery, whereby the content is digitally fed over a conventional telephone circuit and stored in memory. Regardless of its initial source (recording medium or dial-in download), once stored in memory, the production is converted into analog audio and fed to the customer's phone system.

If a customer has multiple locations, each location usually receives a duplicate copy of the produced message, so there is no localization of content. Alternatively, depending on the customer's preference, custom messages for each individual location may be produced and delivered. The company providing this content to the customer typically produces a complete end-to-end message on which the voice elements are overlaid on a music track to create a homogenous production of several minutes' duration. As the on-hold message production is being recorded, the background music track is reduced in volume at set intervals and the voice content inserted over it, then the music audio level is increased until the next voice spot is inserted, and so on.

Key shortcomings of these approaches are: only the telephone circuit dial-in method exists for remotely delivering a completed production to the playback device; recorded media-based systems, whether direct play or memory download, involve substantial studio time and associated expense for preparation of a new production, as well as transit time and expense for shipping the recorded production; in order to change any one element of the existing message production the customer must order a complete new production, incurring added labor cost and delivery time; the customer can exercise virtually no direct control over the production process and must rely on the producer to correctly interpret his or her intentions; if multiple locations are involved, complete, individual end-to-end productions must be made and delivered to each one if any localization of content is desired, increasing production time and expense.

### SUMMARY OF THE INVENTION

According to the present invention, a method is provided for providing a customized audio program for playback to a telephone user system, the method comprising: providing a playback device at a customer location, the playback device being adapted to receive selected music and voice components to constitute the customized program from a provider server via at least one of the Internet or a telephone connection and play the customized audio program to the telephone user system users; providing a selection of music and voice components on the provider server and accessible to customers to produce the customized audio program by selection, combination and sequencing of the music and voice components to create a customer-created customized audio program on the playback device; and, downloading the selected music and voice components to the playback device to constitute the customer-created customized audio program in the playback device at selected customer locations.

The present invention also provides a system for supplying a customized audio program for playback to a telephone local area network, the system comprising: a playback device adapted to receive music and voice components of the customized audio program from a provider server via at least one of the Internet or a telephone connection and play the customized audio program to the telephone local area network; a provider server providing a selection of music and voice components available for review, selection, combination and sequencing by a customer as program components to produce the customized audio program on the playback device; and, a communication path for downloading the program components to the playback device.

### BRIEF DESCRIPTION OF THE DRAWINGS

FIG. 1. is a block diagram illustrating components of the playback device and their inter-relation;

FIG. 2. is a block diagram illustrating the playback device in its Internet-connected configuration, and its placement relative to and interaction with the other components of a typical operating environment;

FIG. 3. is a block diagram illustrating the playback device in its PSTN-connected configuration, and its placement relative to and interaction with the other components of a typical operating environment;

FIG. 4. is a flow chart illustrating the process by which the Internet-configured playback device performs its designed functions and interacts with the user (customer), provider, and key components of its intended operating environment; and,

FIG. 5. is a flow chart illustrating the process by which the PSTN-configured playback device performs its designed functions and interacts with the user (customer), provider, and key components of its intended operating environment.

### DESCRIPTION OF PREFERRED EMBODIMENTS

The present invention provides a method and device to overcome limitations inherent to earlier and existing technologies for providing on-hold messaging. The subject device of this invention plays an audio message, which is fed to the Customer Premises Equipment (CPE), having previously received the message digitally over either a connection to the Internet or a conventional telephone circuit (PSTN), depending on the device configuration. The data constituting the message is stored in digital memory within the device. To assemble a production, the customer or other authorized user accesses a Web-based user interface on a password-protected basis. Only a given user's information and control functions are accessible to that user. “Administrators” are authorized users who are given certain control rights, and are able to specify levels of operability within the scope of their own organization's hierarchy and group of users. For example, restrictions on voice and music element availability may be set by the customer administrator here. The set level of authority and control available to a given user is linked to that user's log-in name and password.

The User Interface provides several menus which contain administrative and production controls, with accessibility to specific areas governed by the user's assigned level. Additionally, text and audio copies of each voice element available to a given user are accessible at this site for preview and selection. The production areas of the user interface allow the customer user to select specific voice elements, which have been previously recorded and stored on a server device located at and/or controlled by the provider company. The writing, voicing, editing, storing and support of these messages are done by and/or under contract to the provider of the on hold messaging service. The customer user is able to view the text for each voice element and to hear the recorded (“voiced”) version of each, by accessing the customer's designated area of the provider Web site. One or more of these voice elements, collectively, constitute the vocal content of the message production. At this site the user may also audition and select from a variety of available music tracks, which are licensed to the provider for this application. During the course of the production process the user may listen to the voice elements first, or may bypass the review and audition process and go directly to selection of the desired spot(s) for the final production. A desired music track can also be auditioned and/or selected in the course of creating the production.

In the process of assembling the production, the user selects the sequential order in which the selected voice elements are played, the interval of background music played between each voice element, and the date and time on which the completed production is to be delivered. In the case of customers with multiple locations, specific locations or designated sub-groups of locations can be individually addressed to specify content, and delivery time and date. Multiple productions can be created and stored with successive future delivery dates assigned to each. These actions may be executed from a customer's centralized location and/or from each of its individual locations, at the discretion of the customer, by accessing the customer's designated area of the provider's Web site and with established levels of password protected access control. Each of the available production elements can be selected independently of the others. Availability of specific elements is determined first by the provider, and can be further controlled or limited within the customer hierarchy, so that only certain elements are available to a given geographical region, for example, in the case of a customer with multiple locations. Once completed, data items, which define the production and correspond to the selected elements of the production are stored in a database until the selected delivery date and time occur. A notification is sent to the user via e-mail, confirming that the system has accepted and stored the requested production, and listing the specific elements and instructions of the production.

The provider database consists of a set of tables which contain records regarding the customers, designated users and other necessary administrative information; unique identifying and physical (customer) location information associated with each playback unit; and data items which define each message production once it is created. The administrative information and the playback unit information are entered by the service providing company. The information regarding each individual production is based on entries made by the user via the designated Web site area.

A playback unit is installed at each physical location where the customer desires to have on-hold messaging played over the premises phone system. In the case of telephone systems which service multiple physical locations from a single control point, a single device may provide the message audio content for the multiple locations by connecting to the single control point. The Internet-configured device is normally connected to the customer's local area network (LAN) by means of a Category 5 or similar cable between the device and an Ethernet connecting point (jack). Alternate ways of connecting the unit to the Internet may also be employed. The device may also be configured with a modem, to allow for remote downloading via a PSTN connection. Operating power is provided to the device by means of a transformer, switching power supply, or other means that converts standard commercial alternating current power to the required direct current voltage used by the device. A cable connects the analog audio output of the device to the MOH audio input port of the premises telephone system-controlling unit. A manual audio volume adjustment control is incorporated into the device. Light Emitting Diodes (LEDs) on the device illuminate to indicate power “ON”, network connectivity and operational status.

The Internet-configured device remains powered on and connected to the LAN or other Internet access point at all times in normal operation. The device autonomously sends an inquiry at power-up and at designated intervals thereafter, nominally every 10 to 120 minutes, to determine whether a production is available for downloading. It does this by contacting a “dispatcher” device which stores data corresponding to all message productions that have been assembled by users accessing the provider interface on the Internet, selecting voice and music elements and specifying other information as to production delivery date and time, music play interval between voice elements, and location(s) to which the production is to be delivered at the specified date/time. If there is no production waiting for that specific playback unit, the device reverts to standby mode and continues playing the last downloaded production. If a replacement production is detected, the unit requests the download. The dispatcher device acquires the voice and music elements from the media on which they are stored at the service provider location and digitally transfers them, along with control information, to the playback device, where they replace the elements previously stored in memory. The music and voice elements are then continuously played back from memory storage in the format of a continual “loop”.

In its PSTN configuration the device also continually plays the message stored in its internal memory. When a replacement message is ready, the provider dispatcher places a call over the PSTN to the download number corresponding to the playback device. This may be a Central Office (CO) line shared with other equipment at the customer premises. When the dispatcher connects with the playback device it downloads the new message production in the same manner as that described for the Internet-configured device.

In both configurations the digital-to-analog converter creates an analog audio output that is amplified within the playback device and fed to the MOH port of the premises telephone system control unit. The playback device plays the music track continually and inserts the voice elements, in the order chosen and with pauses between voice element insertions at the time intervals selected by the creator of the production (typically 5 to 180 seconds). The device reduces the audio level of the music track just before the voice element plays, then restores the music to its nominal level as soon as the voice element completes. Callers who are connected to the customer's premises phone system hear the voice and music elements in the form of a continuous production during the time they are placed on hold. The premises telephone system control unit receives the analog audio signal, further amplifies it and distributes it internally to the MOH circuit of the premises telephone system.

The present invention device is also capable of being remotely programmed (software updates) in a manner similar to the way in which the productions are delivered to the playback unit. Depending on its configuration, updates and other revisions to the controlling program can be retrieved by (Internet configuration) or sent to (PSTN configuration) the unit, which stores and begins using them upon completion of the download.

With the addition of an amplified speaker and, optionally, a wireless LAN connection, the present invention could be used for other applications such as a “talking” vending machine or fuel dispenser, point-of-purchase display, product features narration device, self-guiding tour audio source, tour bus or courtesy van, or other uses which would benefit from having audio elements remotely, easily and quickly updated.

Illustrative embodiments of the present invention are further shown in the Figures.

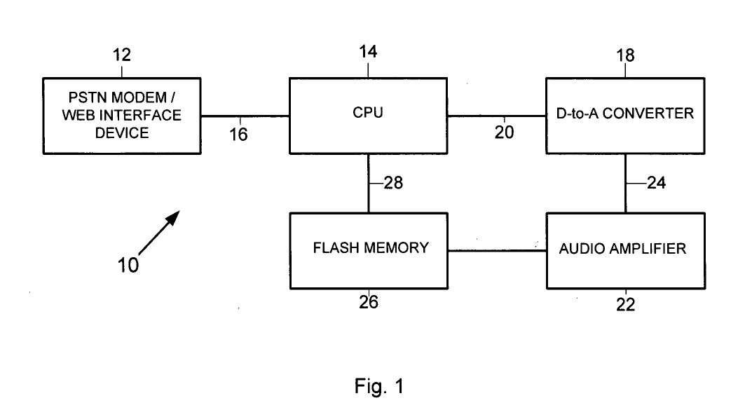

In FIG. 1 an embodiment of a playback unit 10 is shown. Playback unit 10 includes a modem/interface device 12, which provides a communication path from a dispatcher (on a server computer at a central site) (not shown) to playback unit 10. The music and voice elements, the dispatcher program operating parameters and CPU program updates are sent by the dispatcher to the modem/interface 12 via the Internet or a conventional telephone circuit line, depending on the modem/interface device configuration. CPU 14 receives and stores the voice elements, operating parameters and CPU program updates via the modem/interface device 12 and converts them as specified into digital signals sent via a digital-to-analog converter 18 and a communication path 24 to an audio amplifier 22. CPU 14 provides the detailed control and timing for the process using a computer program, which may also be received from the dispatcher. Converter 18 converts a timed sequence of digital sound level values sent via a communication path 20 from CPU 14 into analog voltage levels. A flash memory 26 stores digital signal files received from the dispatcher via modem/interface device 12 under control by the CPU for as long as needed to provide input to the program which converts the data to the digital signals sent to the digital-to-analog converter 18. Flash memory 26 retains the data even when no power is applied to the playback unit. Audio amplifier 22 converts the analog voltage levels supplied by digital-to-analog converter 18 into voltage levels appropriate to the on-hold input of the telephone system (not shown), which further amplifies and distributes it.

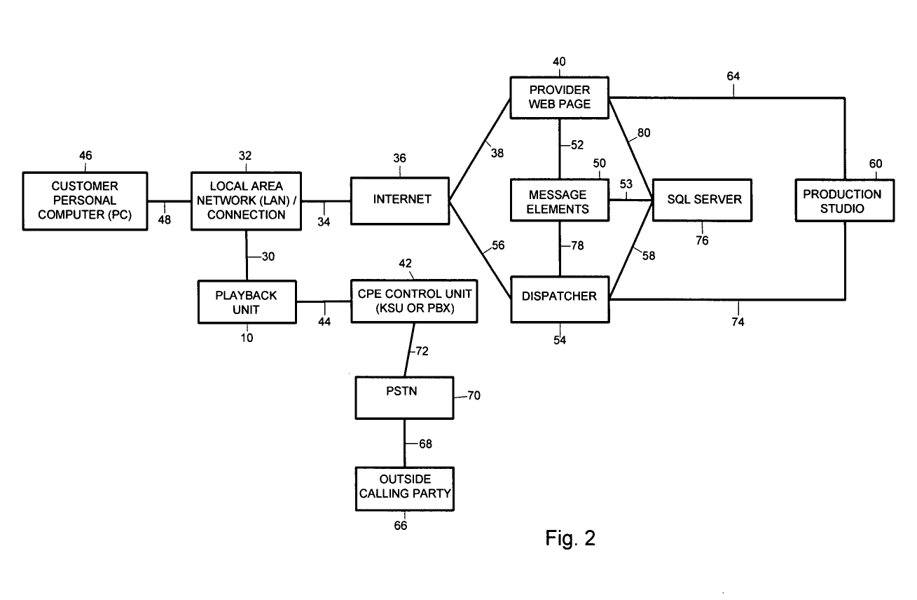

In FIG. 2, an Internet configuration of the playback unit 10 is connected via an Ethernet cable, wireless link or other method (communication path 30) to a LAN 32 or other Internet connection via a communication path 34, which is in turn connected ultimately to an Internet service provider 36, which is in communication via a communication path 38 with a provider Web page 40. A digital memory playback unit section stores data comprising music and voice audio, which has been written into it. The audio output feeds into a Customer Premises Equipment control unit 42 (via a communication path 44), which is typically either a KSU or PBX switch depending on the customer's phone system. The control unit 42 is in communication with a PSTN connection 70 via a communications path 72. For purposes of the present invention, the two types of control units are interchangeable.

The customer may use a personal computer (PC) 46 connected via a communications path 48 to a local area network 32 or other means which is in turn connected to an Internet service provider 36 via a Digital Subscriber Line (DSL), a conventional telephone line or other communications path 34 and accesses provider Web page 40 via Internet 36. By entering an authorized user name and password to log in, the customer is directed to the portion of the provider Web site (via a communications path 52) containing a list of elements which comprise recorded voice elements and music specifically available to that customer. The customer selects the individual voice and music elements desired, then enters the location or locations to which, and the date and time on which these selected production message elements 50 are to be downloaded to the playback units 10. This order is received by the server 76 and stored in its database.

Also stored in server database 76 are data which correspond to each specific installed playback unit, including a location code for each. At its next scheduled polling event, the playback unit contacts a Dispatcher 54 via a communications path 56 and interrogates for any new information awaiting it. Dispatcher 54 queries the server 76 via a communications path 74 to determine whether any productions are due to be downloaded to the playback unit identified by a unique code in the message. If so, the Dispatcher reads the production specifications from the server received via a communications path 58, collects and formats the operational parameters along with the audio file data stored on accessible media in a production studio 60, and downloads them to the playback unit via a communications path 64, where they are stored in memory, converted to analog audio and fed to the customer premises phone system control unit 42. Dispatcher 54 is in communication via communications path 74 with production studio 60. If other action, such as a software version update is called for, this is handled in a similar fashion to the production elements download. The most recent production continues to play until it is updated. When an outside calling party 66 connects via a communications path 68 to a customer location over PSTN 70 and is placed on hold, they hear the downloaded message content, played as a continuous “loop”, with the individual voice elements played over the selected background music. Dispatcher 54 is in communication with message elements 50 via a communication path 78 and server 76 is in communication with Web page 40 via a communications path 80.

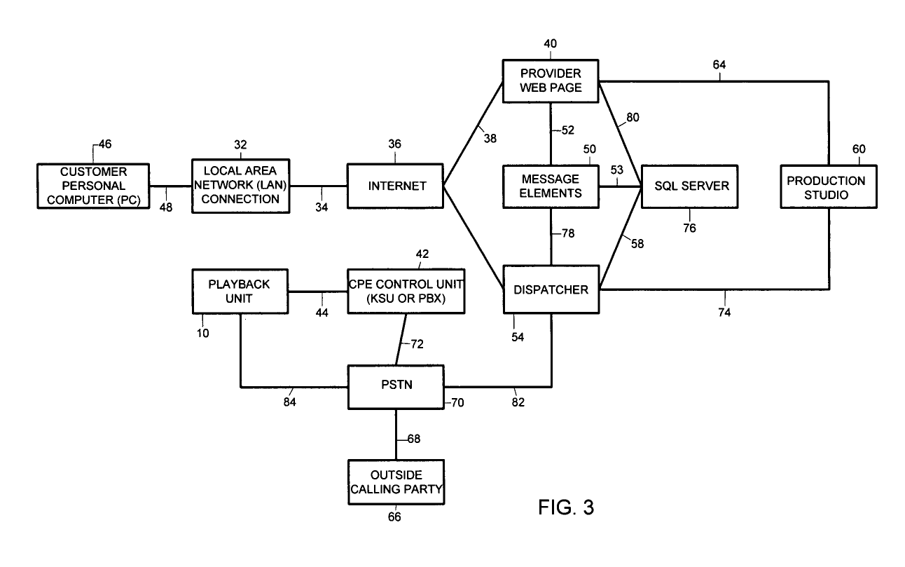

FIG. 3 illustrates the operation of the PSTN-configured playback unit. All components and actions of the process are the same as those of the Internet version (FIG. 2) with one exception: that part of the process whereby the message elements are delivered to the playback unit. In a PSTN configuration, the playback unit does not poll dispatcher 54 periodically as it does in the Internet configuration, but, rather, waits for its dispatcher 54 to call to it over PSTN 70 and download new productions to it at the designated time. In this configuration the playback unit has a modem which allows it to answer the incoming call from dispatcher 54, determine that the call is intended for it, and download the data comprising the new production using established protocols for data transfer by modem over standard telephone lines. In this embodiment, dispatcher 54 is in communication with the PSTN via a communications path 82 and the PSTN is in communication with playback unit 10 via a communications path 84.

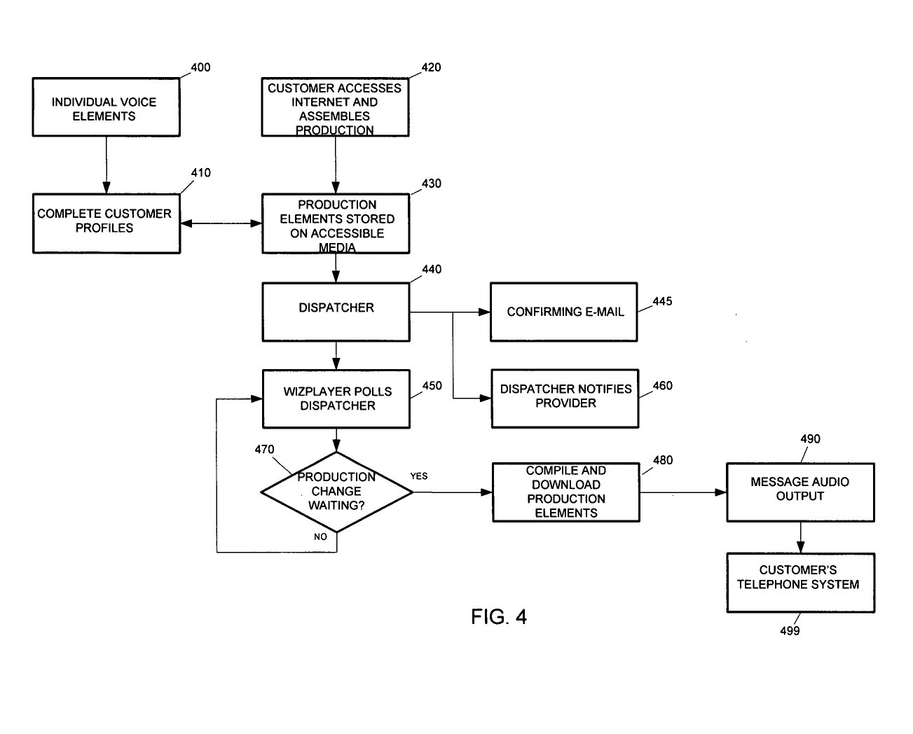

FIG. 4 illustrates the process by which the production elements are prepared, selected, then delivered to and played by the playback unit. At 400 the provider writes, voices (records), edits, and otherwise prepares the individual voice elements for each client as well as those for general use by all clients, and stores them in an access-controlled server 430. Complete information profiles are also stored for each customer location 410. After the customer access the provider Web site and assembles a new production 420, the production elements are pulled from the accessible media where they are stored 430 and matched with the customer profile information. Dispatcher 440 is then notified and given the information regarding customer location, production elements, and scheduled date and time of delivery. The dispatcher sends an e-mail 445 to the customer and to the provider, confirming that it has received the necessary information to deliver the elements for a new production at the designated date and time, to the specific client location or locations. In its Web-based configuration, the playback unit polls the Dispatcher at power-up and at subsequent programmable intervals and checks for new productions, software revisions, or other data. At 470, if a new production (or software update) is waiting, the playback unit receives the download 480 via the dispatcher. If none is waiting, it continues to play the existing message production. In either case the message audio 490 continually feeds into the customer's telephone system 499. If, for some reason, the playback unit does not contact the dispatcher at the designated polling interval, an alert message 460 is sent to the provider advising of the discrepancy.

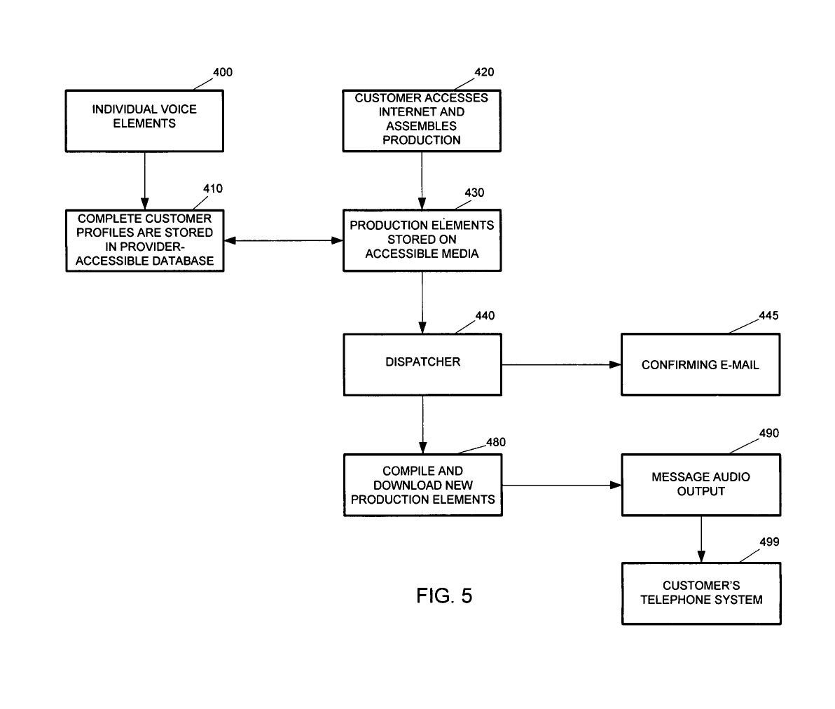

FIG. 5 illustrates the device in its PSTN configuration. All operational aspects are the same as with the Internet configuration, except the dispatcher 440 connects to the playback unit at the specified date and time by dialing into its modem via the PSTN, rather than waiting to be contacted by the playback unit via the Internet as is the case in the Internet configuration. Neither playback unit configuration's production process is distinguishable from the other from the customer perspective and, in fact, both configurations may be used by the same customer having multiple locations, depending upon which configuration best fits each location's characteristics.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

1. A method for providing a customized audio program for playback to a telephone user system, the method comprising:
a) providing a playback device at a customer location, the playback device being adapted to receive selected music and voice components to constitute the customized program from a provider server via at least one of the Internet or a telephone connection and play the customized audio program to the telephone user system users;
b) providing a selection of music and voice components on the provider server and accessible to customers to produce the customized audio program by selection, combination and sequencing of the music and voice components to create a customer-created customized audio program on the playback device; and,
c) downloading the selected music and voice components to the playback device to constitute the customer-created customized audio program in the playback device at selected customer locations.

2. The method of claim 1 wherein the customer produces the customized audio program.

3. The method of claim 1 wherein the playback device is configured to periodically contact the provider server and download any new customized audio program or customized audio program update and revisions on the provider server for the playback device contacting the provider server.

4. The method of claim 1 wherein the provider server periodically calls the playback device and downloads any new customized audio program or new customized audio program updates and revisions on the provider server for the playback device called by the provider server.

5. The method of claim 3 wherein the updates and revisions are produced by the customer.

6. The method of claim 4 wherein the updates and revisions are produced by the customer.

7. The method of claim 1 wherein the playback device comprises a personal computer.

8. The method of claim 7 wherein the personal computer supplies the customized audio program directly to the telephone user system.

9. The method of claim 1 wherein the customer is enabled to review the customized audio program on the playback device.

10. The method of claim 9 wherein the customer is enabled to revise the customized audio program.

11. A system for providing a customized audio program for playback to a telephone local area network, the system comprising:
a) a playback device adapted to received music and voice components of the customized audio program from a provider server via at least one of the Internet or a telephone connection and play the customized audio program to the telephone local area network;
b) a provider server providing a selection of music and voice components available for review, selection, combination and sequencing by a customer as program components to produce the customized audio program on the playback device; and,
c) a communication path for downloading the program components to the playback device.

12. The system of claim 11 wherein the communication path is at least one of the Internet or a telephone connection.

13. The system of claim 11 wherein the display device comprises a personal computer.
